(19) United States
(12) Patent Application Publication
(10) Pub. No.: US 2010/0027923 A1
(43) Pub. Date: Feb. 4, 2010

(54) Roller differential extension guide

(75) Inventor: Guenter Bonat, Lochau (AT)

Correspondence Address: WENDEROTH, LIND & PONACK, L.L.P., 1030 15th Street, N.W.,, Suite 400 East, Washington, DC, 20005-1503, US

(73) Assignee: Fulterer Gesellschaft mbH

(21) Appl. No.: 12/588,072

(22) Filed: Oct. 2, 2009

Related U.S. Application Data
(63) Continuation of application No. PCT/AT2008/000106, filed on Mar. 26, 2008.

(30) Foreign Application Priority Data
Apr. 2, 2007 (AT) 514/2007

(51) Int. Cl. F16C 21/00

(52) U.S. Cl. 384/55

(57) ABSTRACT

A roller differential pull-out guidance for pulling out a pull-out furniture part from a furniture body includes a body rail securable on the furniture body, which rail includes a vertical base web, a pull-out rail securable on the pull-out furniture part, which rail includes a vertical base web, a horizontal flange connected with an upper margin of the base web and a side web extending downwardly from the horizontal flange at a spacing from the vertical base web of the pull-out rail. A center rail is located between the body rail and the pull-out rail and differentially running out between them, on which center rails are rotatably supported track rollers for the mutual displacement of the rails. On the body rail, a retraction unit is secured, which includes a spring-loaded tilt slide, which slide cooperates with an entrainer formed by a downwardly projecting section of the side web of the pull-out rail.

This is a continuation application of International Application PCT/AT2008/000106, filed Mar. 26, 2008, the entire enclosure of which is incorporated herein.

### BACKGROUND OF THE INVENTION

a) Field of the Invention

The invention relates to a roller differential pull-out guidance for pulling out a pull-out furniture part from a furniture body, with a body rail securable on the furniture body, the body rail including a vertical base web, a pull-out rail securable on the pull-out furniture part, the pull-out rail including a vertical base web, a horizontal flange connected with the top margin of the base web, and a side web extending downwardly from the horizontal flange at a spacing from the vertical base web of the pull-out rail. A center rail is disposed between the body rail and the pull-out rail, and differentially runs out between the body rail and the pull-out rail, on which track rollers are rotatably supported for the mutual displacement of the rails.

b) Description of Related Prior Art

In roller pull-out guidances the track rollers serving for the displacement of the rails are supported on the rails rotatably about axes located stationarily with respect to them. Roller pull-out guidances according to the differential design (=roller differential pull-out guidances) have a load-transmitting differential roller rotatably supported on the center rail, whereby the synchronous running or differential running of the rails is attained. The center rail herein travels only one half the path of the pull-out rail compared to the body rail. In such roller differential pull-out guidances, which have a highly developed running culture, all track rollers can advantageously be disposed on the center rail. A roller differential pull-out guidance is described, for example, in AT 391 603 B. Several modified embodiments of such roller differential pull-out guidances are also already known.

Retraction mechanisms for pull-out furniture parts, which, when sliding in the pull-out furniture part, ensure its completely pushed-in state, are known in several embodiment forms. For example, AT 401 334 B discloses a retraction mechanism, in which a tilt slide is provided that is displaceable against the force of a spring. The tilt slide is disposed tiltably about a tilt axis on a carriage displaceable in a straight line in the pull-out direction of the drawer against the force of the spring. In the retraction mechanism disclosed in AT 393 948 B a tilt slide is also provided, which is displaceable along a guide track against the force of a spring. The guide track has a straight section and a curved section which effects the swiveling of the tilt slide about an imaginary axis into its tilted end position.

It is also known to equip such retraction mechanisms with slide-in attenuators in order to attenuate the push-in movement of the pull-out guidance in the last section. Such an attenuated retraction mechanism, in which the tilt slide cooperates with a slide-in attenuator, is disclosed, for example, in EP 1 532 892 A1. The tilt slide of each of said retraction mechanisms cooperates with an entrainer which is disposed on the pull-out furniture part.

In the roller pull-out guidances as further design telescoping pull-out guidances are known in which on all rails are rotatably supported load-transmitting track rollers and in which the pull-out and the center rail are pulled sequentially out of the body rail. At the end of the pull-out path of the pull-out rail from the center rail abutting of a stop element of the pull-out rail occurs on an stop element of the center rail and an impact connected herewith, whereby the running culture is impaired. Therefore pull-outs according to the telescoping design have already been developed in which additional measures are provided in order to attain the simultaneous extending of the rail, such as is the case with pull-outs according to the differential design. Apart from circumferential bands which entail high expenditures, for this purpose an elastic entrainer roller rotatably supported on the center rail and penetrating a window cut-out of the center rail is utilized, which, however, does not represent a load-transmitting roller. Such a telescoping pull-out guidance with differential effect is described for example in AT 392 883 B.

In addition to roller differential pull-out guidances, in which the track rollers are supported on the rails about axes stationary with respect to these track rollers, pull-out guidances which have carriages equipped with balls or cylinders are also known. In comparison to roller pull-out guidances, each of these has its own advantages and disadvantages, wherein the problems encountered in the physical form and construction differ considerably from those of the roller pull-out guidances. Ball pull-out guidances have less good running properties than roller pull-out guidances.

EP 1 561 398 A1 discloses a ball telescoping pull-out guidance, in which a sequentially occurring pulling-out of the pull-out rail and of the center rail from the body rail is effected, with an impact connected herewith. Into this ball telescoping pull-out guidance is integrated a retraction mechanism. In the region of the rear end of the pull-out guidance is secured a retraction unit on the base web of the body rail, and the retraction unit includes a body rail-fixed guidance part and a carriage displaceable along a slotted link of the guidance part. In the end position of the sliding carriage displaced against the force of a retraction spring, the carriage is held by a curved off end section of the slotted link of the guidance part such that it is self-locking. The carriage cooperates via an entrainer pin with an entrainer disposed on the slide-in side end of the pull-out rail. This entrainer is formed by a synthetic part secured on the rail, which part has a control channel for the entrainer pin of the carriage. The control channel comprises a run-in section and a control section extending obliquely hereto. Through this control section the carriage is moved during the pushing-in of the pull-out rail over the curved-off end section of the slotted link and the entrainer pin is pushed in behind a nose-shaped projection of the entrainer, by which the carriage is entrained during the pulling-out of the pull-out rail. Furthermore, a slide-in attenuator is provided which cooperates with the pull-out rail.

### SUMMARY OF THE INVENTION

The invention addresses the problem of providing a roller differential pull-out guidance of the above described type, wherein at a compact formation and simple assembly, a self-retraction for the pull-out furniture part is formed.

This is accomplished according to the invention by a roller differential pull-out guidance for pulling out a pull-out furniture part from a furniture body, comprising

a body rail securable on the furniture body, which rail includes a vertical base web,

a pull-out rail securable on the pull-out furniture part, which rail includes a vertical base web, a horizontal flange connected with the upper margin of the base web, and a side web extending downwardly from the horizontal flange at a spacing from the vertical base web of the pull-out rail, and

a center rail disposed between the body rail and the pull-out rail and differentially running out between these, on which are rotatably supported track rollers for the mutual displacement of the rails,

wherein on the body rail is secured a retraction unit, which has a spring-loaded tilt slide, which cooperates with an entrainer formed by a downwardly projecting section of the side web of the pull-out rail.

A roller differential pull-out guidance according to the invention comprises a retraction unit secured on the body rail, which unit includes a spring-loaded tilt slide. This tilt slide cooperates with an entrainer, which is formed by a downwardly projecting section of the guide web of the pull-out rail.

Through the formation according to the invention, a retraction mechanism integrated into the roller differential pull-out guidance is provided, whereby a compact formation and a simple assembly process results. This result is obtained with an advantageous and simple structure of the roller differential pull-out guidance.

The tilt slide, displaceable from a basic position against the force of at least one retraction spring into an end position in which it is swivelled about a tilt axis, can be supported directly on a body rail-fixed guidance part of the retraction unit such that it is displaceable and tiltable, or be supported tiltably on a carriage, which is displaceable, in particular in a straight line, on a body-fixed guidance part. In the latter case, a slotted link guidance for the tilt slide with respect to the body-fixed guidance part can advantageously be provided in order to attain in every slide position of the carriage a defined swivel position of the tilt slide.

In the tilted end position the tilt slide is secured self-retainingly against being pulled back by the retraction spring and in this end position the entrainer can come out of engagement of the tilt slide. During the pushing-in of the pull-out rail the tilt slide comes into engagement with the entrainer, wherein the self-retaining state is cancelled by swivelling back about its tilt axis and, consequently, the pull-out rail is pulled in by the retraction spring into the completely pushed-in state of the pull-out rail.

A slide-in attenuator attenuating the retraction through the at least one retraction spring is advantageously also provided, and the attenuator preferably cooperates with the tilt slide. In an advantageous embodiment form a part of the slide-in attenuator to be moved during the attenuation process can herein be connected with the carriage swivellably supporting the tilt slide.

In a preferred embodiment form of the invention, the tilt slide comprises at least one guidance pin, which is guided in a slotted guidance link of the guidance part of the retraction unit, and the slotted guidance link has a downwardly curved-off section in the proximity of its pull-out end.

If, within the scope of this document, reference is made to “front” and “back”, this is related to the pull-out direction of the pull-out rail from the body rail.

### BRIEF DESCRIPTION OF THE DRAWINGS

Further advantages and details of the invention will be explained in the following in conjunction with the enclosed drawings, in which:

FIG. 1 is an oblique view of a roller differential pull-out guidance according to the invention in the slide-in state,

FIG. 2 shows the pull-out guidance in the pulled-out state,

FIGS. 3 and 4 are oblique views of the body rail from several sides,

FIGS. 5 and 6 are oblique views of the pull-out rail from several sides,

FIGS. 7 and 8 are oblique views of the center rail from several sides,

FIG. 9 is a side view of a rear section of the pull-out guidance, in the slide-in state,

FIG. 10 is a side view corresponding to FIG. 9, however with the pull-out rail pulled out up to shortly before the swivelling of the tilt slide,

FIG. 11 is a side view corresponding to FIG. 9, however with the pull-out rail pulled out so far that it is separated from the tilt slide,

FIG. 12 to 14 are side views corresponding to FIG. 9 to 11, however with the pull-out rail omitted,

FIG. 15 to 17 are side views corresponding to FIG. 9 to 11 from the opposite side, the body rail being omitted,

FIG. 18 is a side view corresponding to FIG. 16, with the guidance part broken open in the proximity of the tilt slide,

FIG. 19 is an exploded depiction of the retraction unit (without the retraction spring),

FIG. 20 is a front-end view of the retraction unit,

FIG. 21 to 23 are sectional depictions through line A-A of FIG. 20 in the positions of the tilt slide corresponding to FIG. 9 to 11 (without the retraction spring),

The Figures are drawn to diverse scales.

### DETAILED DESCRIPTION OF THE PREFERRED EMBODIMENTS

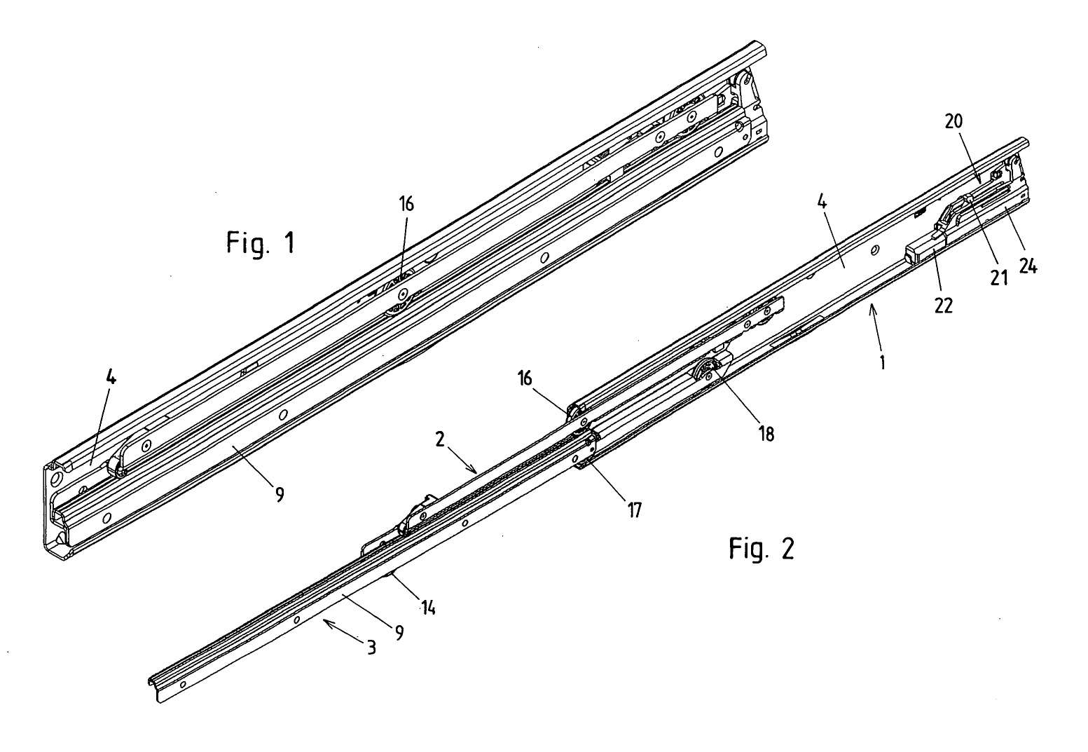

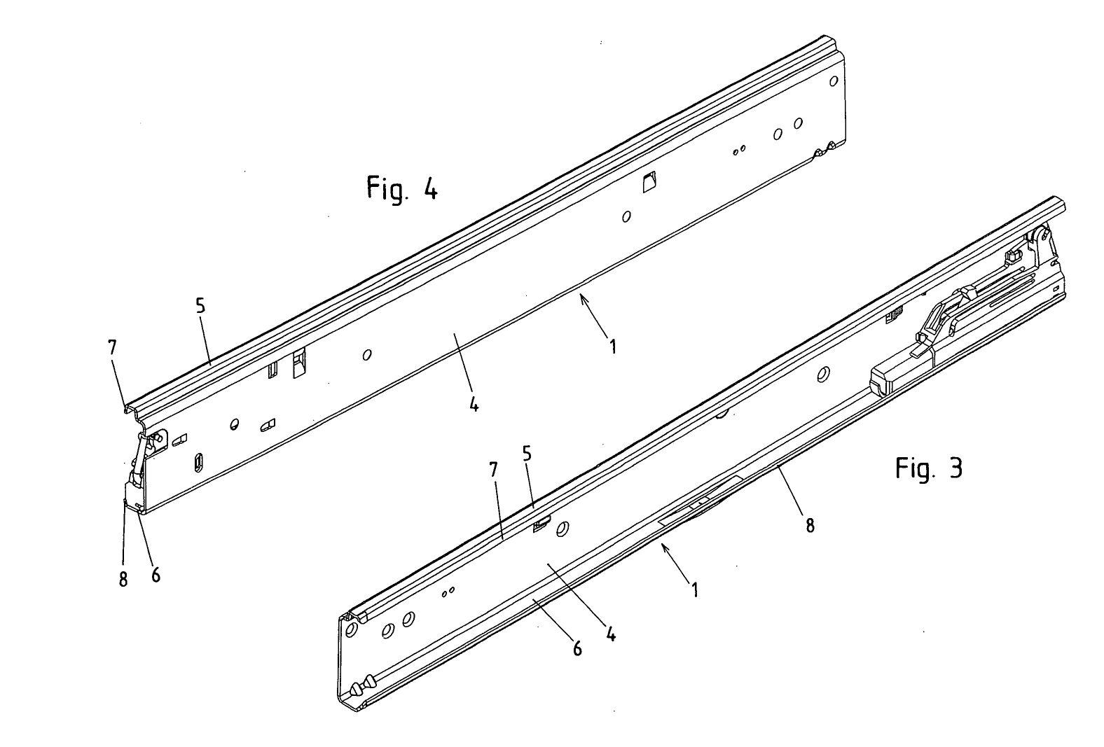

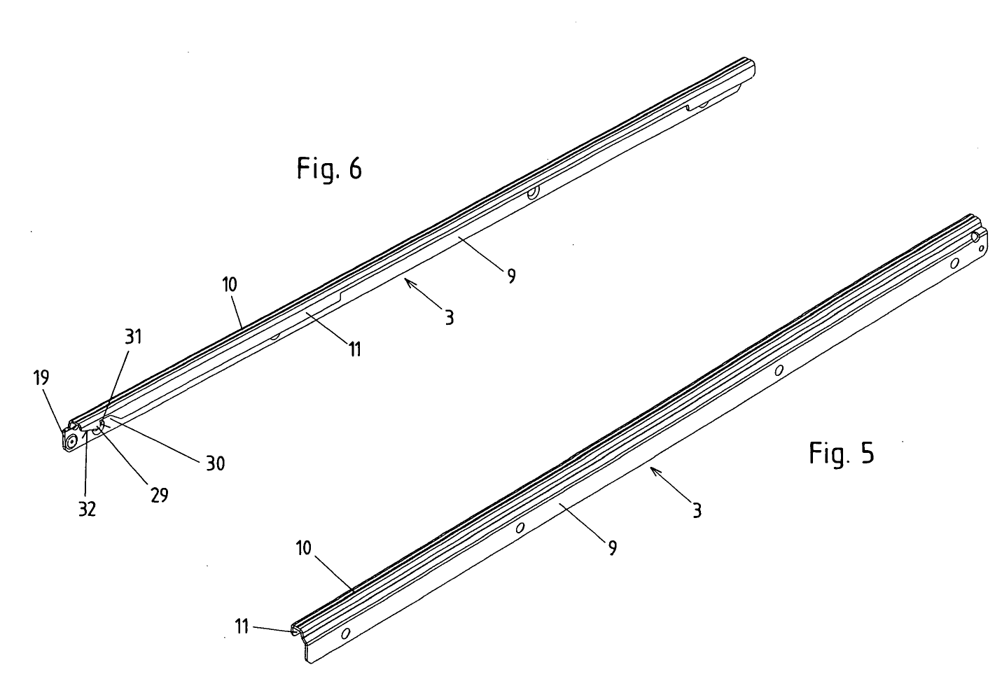

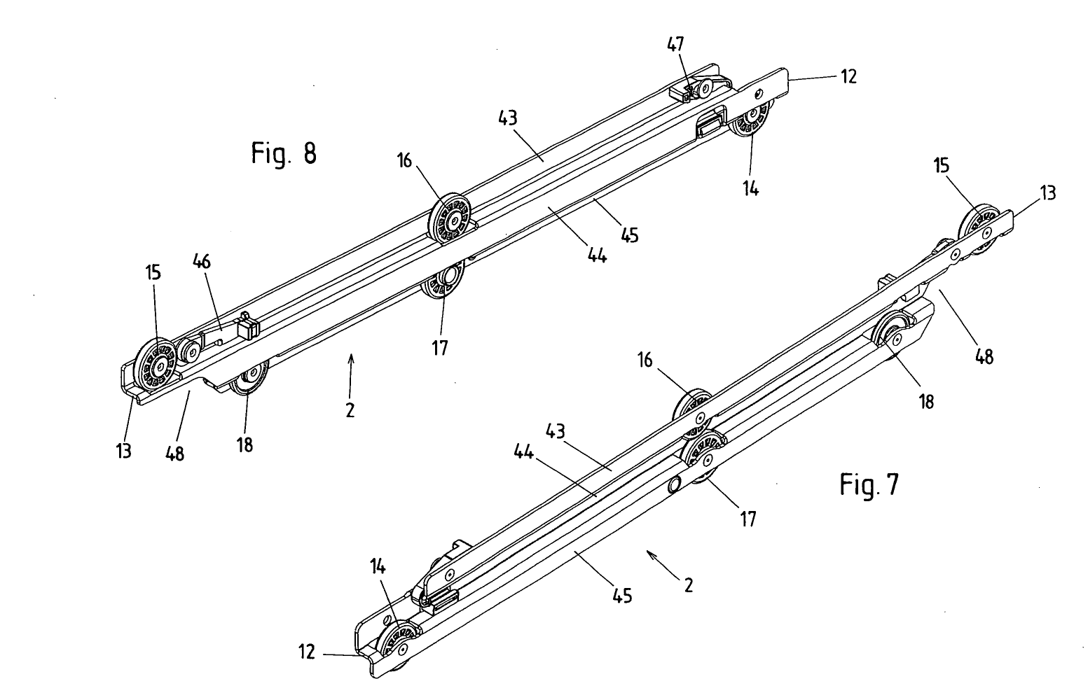

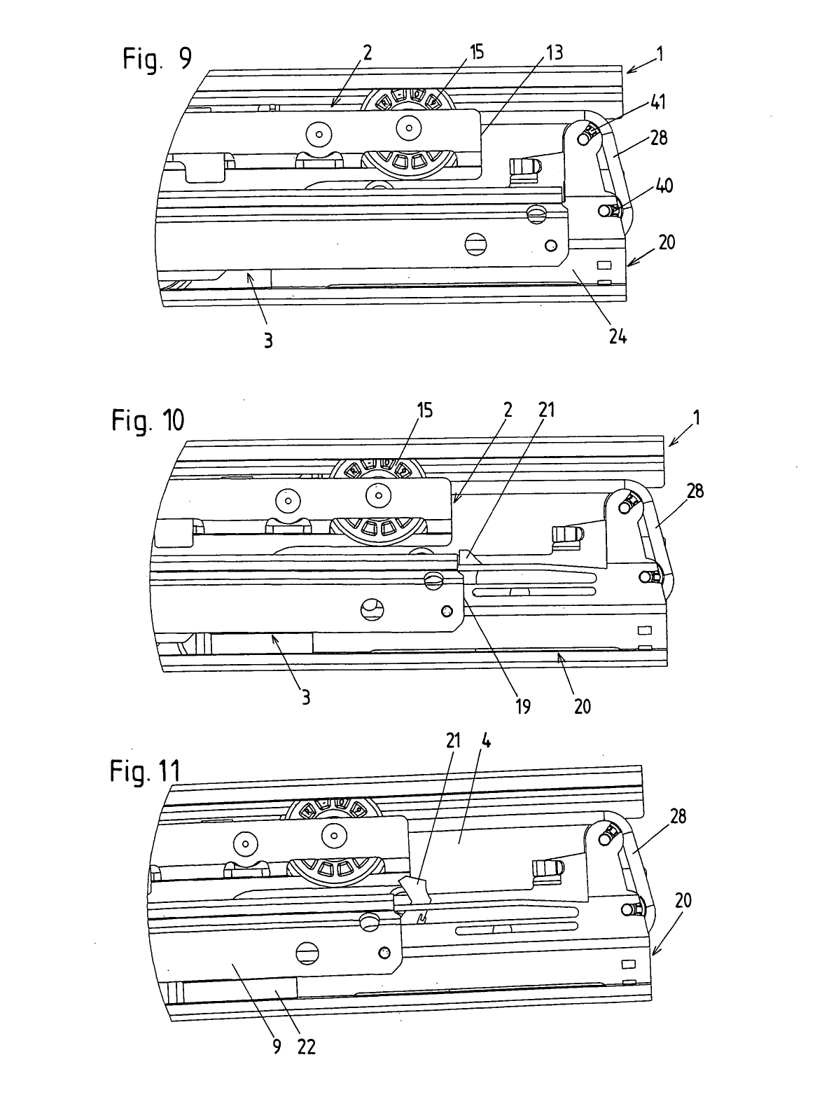

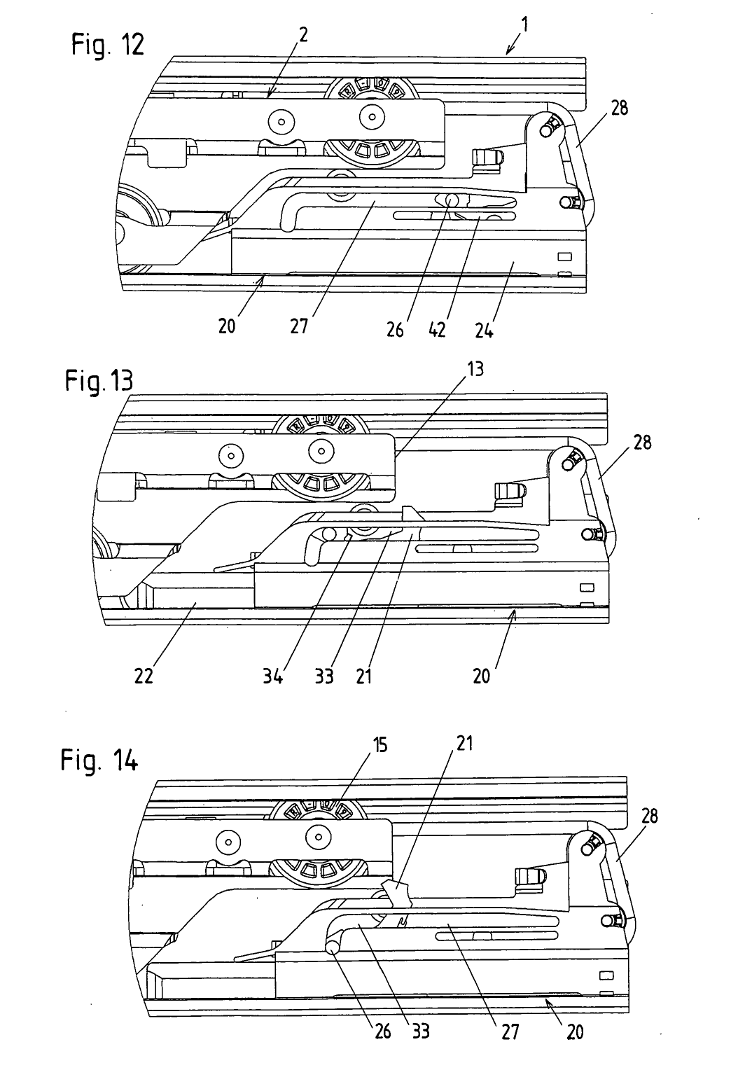

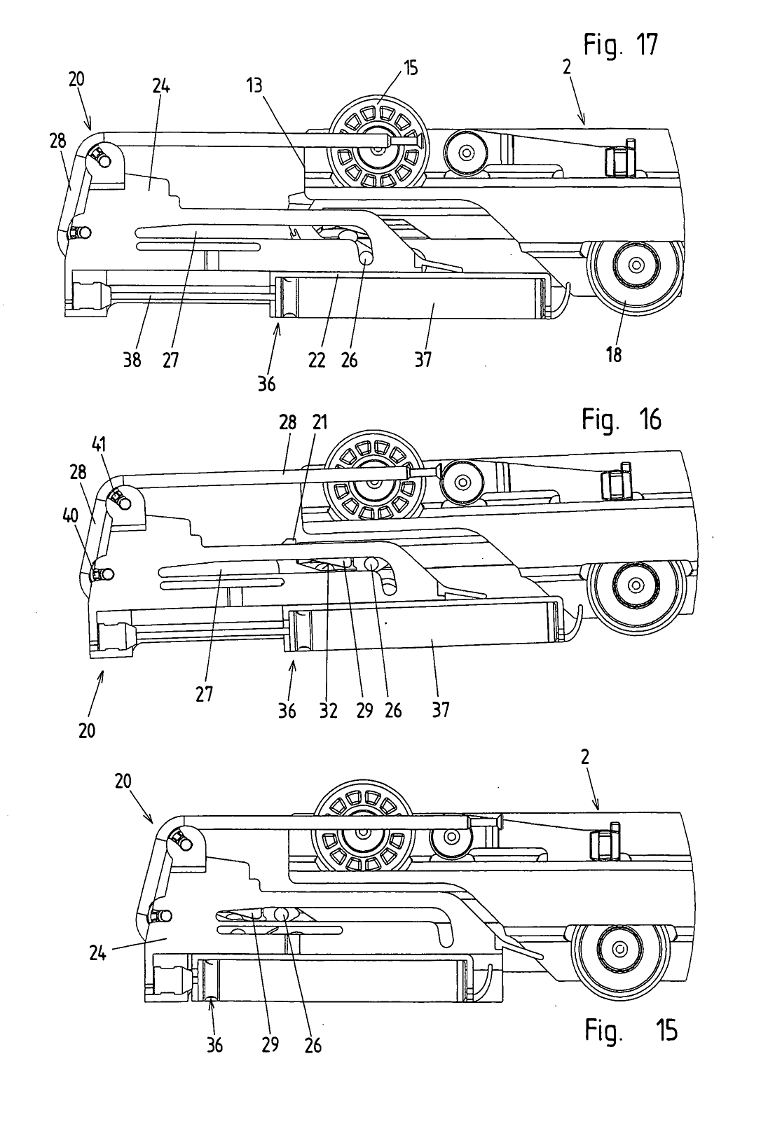

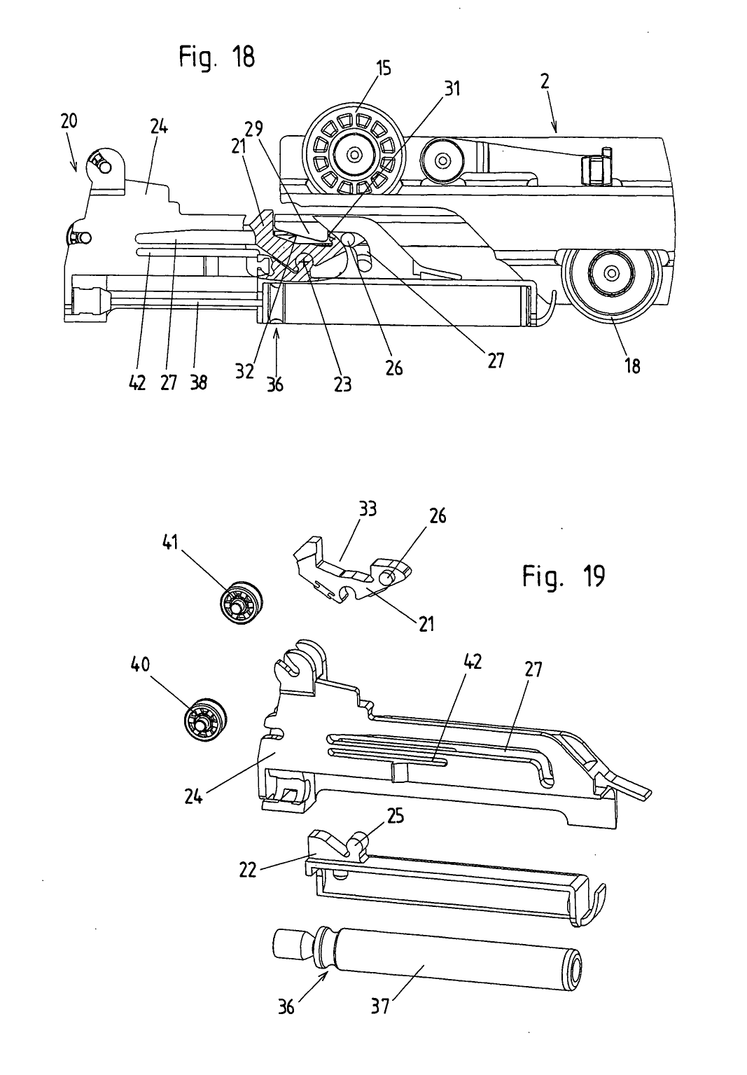

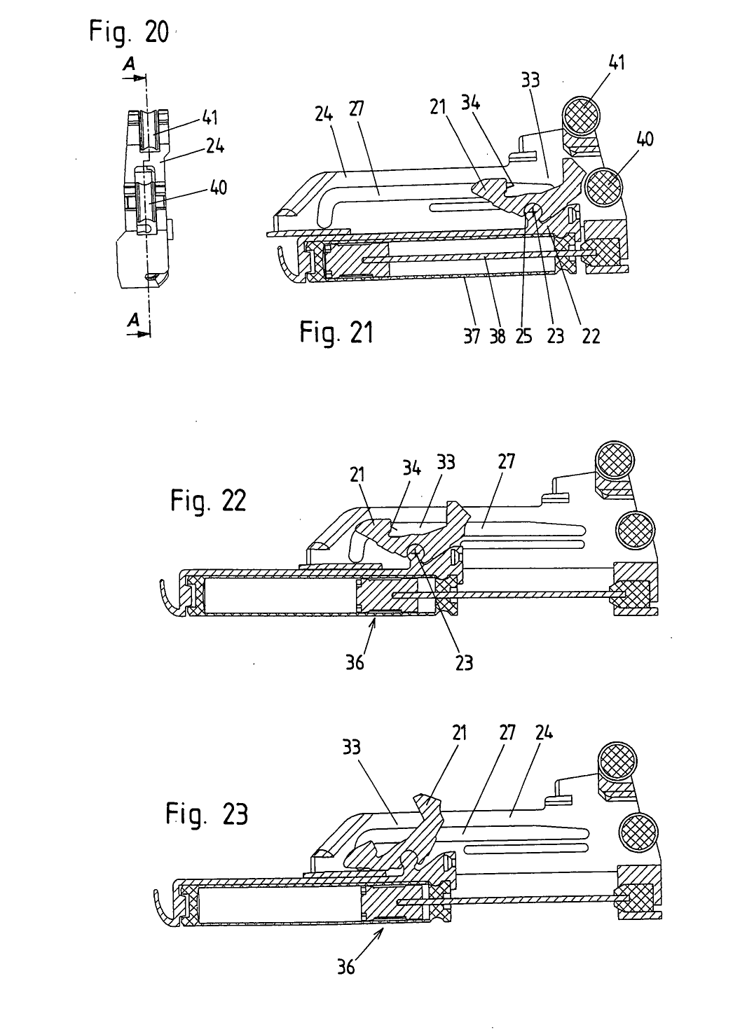

In FIG. 1 to 23 is depicted an embodiment of a roller differential pull-out guidance according to the invention. This pull-out guidance serves for pulling out a movable furniture part, for example a drawer, from a furniture body (not shown in FIG. 1) in a pull-out direction 35 and comprises a body rail 1, to be secured on the furniture body; a pull-out rail 3, to be secured on the pull-out furniture part, and a center rail 2 disposed between these, on both sides of the pull-out furniture part. The rails disposed on the two sides of the pull-out furniture part are herein formed mirror-symmetrically with respect to one another.

The body rail 1 has a vertical base web 4, with which it is in contact on the furniture body after it has been secured, and upper and lower horizontal flanges 5, 6 connected with the base web 4 at its upper and lower margin. These flanges can be connected, for example via offsets, with the base web, as is the case in the depicted embodiment example for the upper horizontal flange 5. The horizontal flanges 5, 6 are preferably provided toward their free margins with beadings 7, 8 directed toward one another.

The pull-out rail 3 includes a vertical base web 9, a horizontal flange 10 connected with the upper margin of the base web 9, and a side web 11 extending downwardly from the horizontal flange 10 at its margin remote from the vertical base web 9 of the pull-out rail 3. The side web 11 is shorter than the vertical base web 9 and consequently extends less far downwardly. The horizontal flange 10 can be connected with the base web 9, as shown, via an offset.

The securement of the pull-out rail 3 on the pull-out furniture part in the depicted embodiment example takes place on the vertical base web 9. Instead, for example, from the lower margin of the vertical base web could also extend a lower horizontal flange (into the opposite direction as the horizontal flange 10), on which rests the pull-out furniture part in contact.

The track rollers for the mutually displaceable guidance of rails 1, 2, 3 are rotatably supported on the center rail 2. Herein are a front track roller 14 rotatably supported on the center rail 2 in the proximity of its front end 12, a rear track roller 15 in the proximity of its rear end 13, and a central track roller 16 and a differential roller 17 in its central region.

The front track roller 14 cooperates with a track on the underside of the horizontal flange 10 of the pull-out rail 3 and braces the pull-out rail 3 in the pulled-out stage of the rails against tilting downwardly.

The rear track roller 15 cooperates with a track on the underside of the upper horizontal flange 5 of the body rail 1 and braces the rear end 13 of the center rail 2 in the pulled-out state of the pull-out guidance against swivelling upwardly.

The center track roller 16 cooperates with a track on the top side of the horizontal flange 10 of the pull-out rail 3 and, in the pulled-out state of the rails, forms a counter bearing for the pull-out rail 3 (against the swiveling of the pull-out rail upwardly).

The differential roller 17 cooperates with a track on the top side of the lower horizontal flange 6 of the body rail 1 as well as also with the track on the underside of the horizontal flange 10 of the pull-out rail 3 and effects the differential running of the center rail 2. From the differential roller 17 a load can be transmitted from the pull-out rail 3 directly onto the body rail 1. The differential roller 17 is advantageously supported with play with respect to its rotational axis, as is known and customary. A shaftless bearing of the differential roller 17 on the center rail 2 or a bearing on an axle, which with respect to the center rail 2 acts with play in the vertical direction, is conceivable and feasible.

Furthermore, on the center rail 2 is advantageously supported an auxiliary roller 18 with play with respect to its rotational axis and specifically in a region between the differential roller 17 and the rear end 13 of the center rail 2 of the longitudinal extension of the center rail 2. This auxiliary roller 18 serves for bracing against a downward tilting the rear end 19 of the pull-out rail 3 in the pushed-in state or only minimally pulled-out state of the pull-out guidance.

Further auxiliary rollers 18 can, in principle, also be provided. It would also, in principle, be conceivable and feasible to support rotatably, instead of the depicted auxiliary roller 18, at least one auxiliary roller in the region between the central track roller 16 and the front track roller 14 on the center rail 2, and the auxiliary roller cooperates with the track on the top side of the horizontal flange 10 of the pull-out rail 3.

In addition to the differential roller 17, the central track roller 16 could also be supported with play with respect to its axle. In this case, the differential roller 17 could also be supported free of play on its axle, wherein between the tracks and the track rollers in this case only minor play should be provided in order to attain during a load change when pulling-out the furniture part a tilt-free movement of the guidance.

In the depicted embodiment, the center rail 2 includes two offsets, whereby a upper vertical section 43, a central vertical section 44 and a lower vertical section 45 results, of which the upper and the lower vertical section 43, 45 are located vertical one above the other and the central vertical section 44 is laterally offset with respect thereto. The rear track roller 15 and the central track roller 16 are rotatably supported at the upper vertical section 43. The front track roller 14, the differential roller 17 and the auxiliary roller 18 are rotatably supported on the lower vertical section 45.

Stops 46, 47 are adjustable in conventional manner for the putting together and dismantling of rails 1-3.

The center rail 2 could also have another formation known from roller differential pull-out guidances, at a formation with a continuous vertical base web, from which project horizontal flanges at the upper and lower margin, as can be found in the prior art listed in the description introduction.

The center rail 2 includes in its rear end section a cutout 48 starting from its lower margin and extending up to its rear end. Through this cutout 48, a free space for the retraction unit 20, described in the following, is formed, when the pull-out guidance is in its retracted state.

In the rear end region of the body rail 1, a retraction unit 20 is secured on this body rail 1, in particular on the base web 4 and/or on the lower horizontal flange 6. The retraction unit 20 is herein in contact on the base web 4 of the body rail 1.

The retraction unit 20 includes a lever-like tilt slide 21, which is supported on a carriage 22 such that it is swivellable about a tilt axis 23. The carriage 22 is supported displaceably in a guidance part 24. The tilt slide 21 can advantageously be connected with the carriage 22 by snapping a swivel head 25 of the carriage 22 into a recess of the tilt slide 21 receiving such, whereby a simple assembly results.

The tilt slide 21 includes bilaterally projecting guidance pins 26 which engage into slotted links 27 of the guidance part 24 disposed on both sides of the tilt slide 21. The slotted links 27 include a section extending in the pull-out direction 35 and, in the proximity of its front end a downwardly curved-off section. The swivel position of the tilt slide 21 is thereby uniquely defined in every displacement position of carriage 22.

The carriage 22 is acted upon by a retraction spring 28.

The tilt slide 21 cooperates with an entrainer, which is formed by a downwardly projecting section 29, exposed by a cutout 30, of side web 11 of the pull-out rail 3. This section 29 forming the entrainer is located in the proximity of the rear end 19 of the pull-out rail 3. It preferably forms the rear end of side web 11.

Section 29 of side web 11 of the pull-out rail 3 includes an entrainer face 31 directed into the pull-out direction (formed by a narrow side of the metal sheet forming the side web 11) and an oblique face 32 located closer to the rear end 19. The oblique face is formed by the lower margin of the side web 11 extending obliquely upwardly toward to the rear end 19 and by which is provided an error function securement described below.

In the completely pushed-in state of the pull-out guidance, the tilt slide 21 is in its basic position cf. for example FIG. 21). The section 29 forming the entrainer engages herein into an indentation 33 of the tilt slide 21.

When, starting from its completely pushed-in position, the pull-out rail 3 is being pulled out, the entrainer face 31 of section 29 comes to lie in contact on a contact face 34 of the tilt slide 21 directed counter to the pull-out direction 35 and displaces the tilt slide 21 in the direction of a front end position. The state, shortly before this front end position is reached, is shown in FIGS. 10, 13, 16, 18 and 22. When the pull-out rail 3 is pulled out further, the tilt slide 21 starts swivelling until the state, shown for example in FIG. 23, is assumed in which the section 29 can move out of the indentation 33. In this front, tilted end position the tilt slide 21 is held by the curved-off section of the slotted link 27 against the force of the retraction spring 28 and thus becomes self-locking.

When sliding in the pull-out rail, the rear (frontal face) end of section 29 abuts the tilt slide 21 and displaces it rearwardly, wherein it tilts back in the direction of the swivel position assumed in the basic position such that the self-locking is cancelled and the retraction spring 28 retracts the tilt slide 21 back in the direction of its basic position.

It would in principle also be possible to provide only one guidance pin and one slotted link 27. The guidance pin 26 and the slotted link 27 could, in principle, also be omitted entirely, as is known, for example, from the prior art described in the introduction to the specification in regard to retraction mechanisms. On the other hand, the carriage 22 could also be omitted and the lever-like tilt slide 21 could also be displaceably supported, for example by means of two guidance pins, in one slotted link or by means of two guidance pins each in opposing slotted links, as is also known from the prior art described in the introduction to the specification.

The tilt slide 21 cooperates with a slide-in attenuator 36, in order to attenuate the push-in movement of the pull-out guidance in its last section in which the tilt slide 21 is displaced between a front end position and its basic position. In the depicted embodiment example this slide-in attenuator 36 is connected with the carriage 22, and specifically, for example, as shown the slide-in attenuator 36 is formed in the form of a piston-cylinder unit, wherein the cylinder 37 is secured on carriage 22 and the piston rod 38 on the guidance part 24. Hereby good protection against dirt of the slide-in attenuator 36 disposed between guidance part 24 and base web 4 of the body rail 1 can be attained. The disposition within a housing-like guidance part 24 is also conceivable and feasible. The reverse disposition, in which the cylinder 37 is secured on guidance part 24 and the piston rod 38 on carriage 22, is also conceivable and feasible.

The retraction spring 28 engages at its one end with carriage 22 (it is held in a recess) and is held at its other end by body rail 1, and specifically on base web 4. In between, it is deflected about first and second deflection rollers 40, 41. These deflection rollers are preferably rotatably supported on guidance part 24 and, with respect of the vertical base web 4, are located at different levels.

The retraction spring 28 and/or the slide-in attenuator 36 can also engage directly on tilt slide 21.

In the pushed-in state of the pull-out guidance, the retraction unit 20 is located at least partially in the interspace between the vertical base web 4 of body rail 1 and the vertical base web 9 of the pull-out rail 3.

A so-called “error function” of the retraction mechanism exists if the tilt slide 21 in the pulled-out state of the pull-out guidance is in its basic position. If, in this state of the tilt slide 21, the pull-out rail is pushed in the oblique face 32 comes to lie in contact on the tilt slide 21 and can be moved over its front end, wherein the front end of the tilt slide 21 is progressively deflected downwardly until section 29 reaches the proximity of the indentation 33 of tilt slide 21. To make possible the deflection of the front end of tilt slide 21 downwardly (under swivelling about the tilt axis 23), the guidance part 24 is comprised, at least in the proximity of the slotted links 27, of a sufficiently elastic material. Beneath a rear end section of the particular slotted link 27, furthermore, is located a slit-form cutout 42, such that between the slotted link 27 and the slit-form cutout 42 only a relatively small material thickness remains.

The guidance part 24 is preferably comprised of synthetic material. The tilt slide 21 and the carriage 22 can also be comprised of synthetic material.

Rails 1, 2, 3 are preferably comprised of a bent sheet metal.

While the preceding specification and the drawings represent the invention, it is obvious to a person of skill in the art that various modifications can be carried out therein without leaving the true spirit and scope of the invention, which should be determined with reference to the cited claims together with their full range of possible equivalents.

### LEGENDS TO THE REFERENCE NUMBERS

1 Body rail
2 Center rail
3 Pull-out rail
4 Vertical base web
5 Upper horizontal flange
6 Lower horizontal flange
7 Beading
8 Beading
9 Vertical base web
10 Horizontal flange
11 Side web
12 Front end
13 Rear end
14 Front track roller
15 Rear track roller
16 Central track roller
17 Differential roller
18 Auxiliary roller
19 Rear end
20 Retraction unit
21 Tilt slide
22 Carriage
23 Tilt axis
24 Guidance part
25 Swivel head
26 Guidance pin
27 Slotted link
28 Retraction spring
29 Section
30 Cutout
31 Entrainer face
32 Oblique face
33 Indentation
34 Contact face
35 Pull-out direction
36 Slide-in attenuator
37 Cylinder
38 Piston rod
39 Cutout
40 Deflection roller
41 Deflection roller
42 Slit-form cutout
43 Upper vertical section
44 Central vertical section
45 Lower vertical section
46 Stop
47 Stop
48 Cutout

1-15. (canceled)

16. A roller differential pull-out guidance for pulling out a pull-out furniture part from a furniture body, comprising:
a body rail securable on the furniture body, which rail includes a vertical base web,
a pull-out rail securable on the pull-out furniture part, which rail includes a vertical base web, a horizontal flange connected with the upper margin of the base web and a side web extending downwardly from the horizontal flange at a spacing from the vertical base web of the pull-out rail, and
a center rail located between the body rail and the pull-out rail and differentially running out between them, on which are rotatably supported track rollers for the mutual displacement of the rails,
wherein on the body rail a retraction unit is secured, which includes a spring-loaded tilt slide which cooperates with an entrainer formed by a downwardly projecting section of the side web of the pull-out rail.

17. The roller differential pull-out guidance of claim 16, wherein the section in this state of the tilt slide, forming the downwardly projecting entrainer of the side web is located in the proximity of the rear end of the pull-out rail.

18. The roller differential pull-out guidance of claim 17, wherein the downward projecting section of the side web forming the entrainer forms the rear end of the side web.

19. The roller differential pull-out guidance of claim 16, wherein the downwardly projecting section forming the entrainer is exposed through a cutout in the side web located in front of this section by a section of the side web extending in front of this cutout.

20. The roller differential pull-out guidance of claim 16, wherein the downwardly projecting section forming the entrainer comprises an entrainer face directed toward the front end of the pull-out rail and an oblique face located opposite the entrainer face closer to the rear end of the pull-out rail, which is formed by the lower margin of the side web extending obliquely upwardly toward the rear end of the pull-out rail and by means of which the front end of the tilt slide in its basic position can be driven over for the formation of an error function securement.

21. The roller differential pull-out guidance of claim 20, wherein the front end of the tilt slide located in its basic position when driving over is deflected downwardly by the oblique face of the section forming the entrainer.

22. The roller differential pull-out guidance of claim 16, wherein the tilt slide includes at least one guidance pin, which is guided in a slotted link of a body rail-fixed guidance part of the retraction unit, wherein the slotted link includes in the proximity of its front end a downwardly curved-off section.

23. The roller differential pull-out guidance of claim 16, wherein the tilt slide is supported on a carriage swivellably about a tilt axis, and that the carriage is supported displaceably with respect to a body rail-fixed guidance part of the retraction unit.

24. The roller differential pull-out guidance of claim 23, wherein the carriage is supported such that it is displaceable in a straight line with respect to the guidance part of the retraction unit.

25. The roller differential pull-out guidance of claim 23, wherein for the spring loading of the tilt slide at least one retraction spring engages on the carriage.

26. The roller differential pull-out guidance of claim 16, wherein at least one retraction spring serving for spring loading the tilt slide is deflected about two deflection rollers preferably rotatably supported at different levels at a body rail-fixed guidance part of the retraction unit, and subsequently extends to the deflection rollers toward an end secured on the body rail in the pull-out direction.

27. The roller differential pull-out guidance of claim 16, wherein for the formation of a free space, which receives at least partially the retraction unit in the pushed-in state of the pull-out guidance, the center rail includes a cutout starting from its rear end and its lower margin.

28. The roller differential pull-out guidance of claim 16, wherein the retraction unit in the pushed-in state of the pull-out guidance is located at least partially in an interspace between the vertical base web of the body rail and the vertical base web of the pull-out rail.

29. The roller differential pull-out guidance of claim 16, wherein the retraction unit is in contact on the vertical base web of the body rail.

30. The roller differential pull-out guidance of 16, wherein the tilt slide cooperates with a slide-in attenuator.

31. The roller differential pull-out guidance of claim 30, wherein the slide-in attenuator engages on a carriage supported displaceably with respect to the body rail-fixed guidance part, on which the tilt slide is supported swivellably about the tilt axis.

32. Roller differential pull-out guidance of claim 16, wherein on the center rail in the proximity of its front end a front track roller, in the proximity of its rear end a rear track roller and in its central region at least one central track roller and one differential roller are rotatably supported.

33. Roller differential pull-out guidance of claim 16, wherein the retraction unit is secured on the body rail in the proximity of its rear end.
